(19) United States
(12) Patent Application Publication
(10) Pub. No.: US 2011/0209116 A1
(43) Pub. Date: Aug. 25, 2011

(54) Programming Method and System For DAQ-Containing Device

(75) Inventors: Larry L. Roy, Rochester, MI (US); Deborah C. McLeod, Romeo, MI (US)

(73) Assignee: EMBEDDED LOGIX, INC., Shelby Township, MI (US)

(21) Appl. No.: 13/030,811

(22) Filed: Feb. 18, 2011

Related U.S. Application Data
(60) Provisional application No. 61/306,188, filed on Feb. 19, 2010.

(51) Int. Cl. G06F 9/44; G06F 9/45

(52) U.S. Cl. 717/107; 717/106

(57) ABSTRACT

A programmable data acquisition system capable of selectively physically disconnecting a data acquisition element and memory element of the system from a processing element of the data acquisition system and connecting the data acquisition element and memory element to an external programming connector when the external programming connector is connected to an external application development device such that a processor of the external application development device can access the data acquisition element and memory element for generation of an application program for implementation by the processing element. A method of building an original application program on the data acquisition system using an external application development device via selective disconnecting and reconnecting of the data acquisition element and memory element of the system from a processing element of the data acquisition system.

### RELATED APPLICATION DATA

This application claims the benefit of priority of U.S. Provisional Patent Application Ser. No. 61/306,188, filed Feb. 19, 2010, and titled “Programming Method and System for DAQ-Containing Device,” which is incorporated by reference herein in its entirety.

### FIELD OF THE INVENTION

The present invention generally relates to the field of programming data acquisition devices. In particular, the present invention is directed to a programming method and system for a data acquisition-containing device.

### BACKGROUND

Data acquisition (commonly referred to as DAQ in the field) is the process of sampling physical, electrical, and other real world properties to be measured, such as temperature, pressure, voltage, current, sound, fluid flow, force, light intensity, and frequency. The sampled conditions are often converted to digital values from analog waveforms for analysis by a computing device and usually presentation and/or storage of the resultant information. Data acquisition systems typically include one or more sensors for detecting the real world condition of interest; a data acquisition device for conditioning signals from the one or more sensors to a form that can be converted to desired digital values (e.g., amplifying, deamplifying, linearization, filtering, demodulating, etc.), digitizing the signals, and/or providing counter/timing functionality; a processing resource, such as a computing device; software for analyzing the data; and software for managing the interface between the data acquisition device, sensors, and processing elements. Signal conditioning can be separated from the DAQ device in some systems. Often DAQ systems are very specific in their functionality and include specific sensors, DAQ device circuitry, and specific software for that hardware and a given analytical task. These types of systems are rigid in their application. Some DAQ systems have been adapted to allow for flexibility in the types of sensors that can be connected and/or the types of conditions to be monitored. However, when the DAQ system is required to utilize new sensors, to be connected to different sources of real world conditions (e.g., a different machine being monitored), and/or analyze different conditions, the software that manages the hardware and/or the software for analyzing the data often needs to be replaced and/or modified.

### SUMMARY OF THE DISCLOSURE

In one embodiment, a method of building an original application program for operating with a data acquisition device of a computing device having an external programming connector and a first processing element is provided. The method includes disconnecting the first processing element from the data acquisition device and connecting the data acquisition device via the external programming connector to an external application development device; programming an application program for implementation on the computing device using the a second processing element of the external application development device and information from the data acquisition device; storing the application program in a memory element of the computing device; and disconnecting the data acquisition device from the external application development device and connecting the data acquisition device to the first processing element.

In another embodiment, a method of building an original application program for operating a computing device having a data acquisition device and processor is provided. The method includes connecting a first computing device having a first processing element to a second computing device via an external programming connector of the second computing device, the second computing device having a second processing element and a data acquisition device; automatically connecting the external programming element to the data acquisition device and disconnecting the second processing element from the data acquisition device; generating an application program for implementation on the second computing device using the first processing element and information from the connection to the data acquisition device; storing the application program in a memory element of the second computing device; disconnecting the first computing device from the external programming connector; and automatically connecting the data acquisition device to the second processing element and disconnecting the data acquisition device from the external programming connector.

In yet another embodiment, a data acquisition system is provided. The data acquisition system includes a processing element; a data acquisition element connected via a wired connection to the processing element; a memory element connected via a wired connection to the processing element; an external programming connector; means for selectively physically disconnecting the data acquisition element and memory element from the processing element and connecting the data acquisition element and memory element to the external programming connector when the external programming connector is connected to an external application development device such that a processor of the external application development device can access the data acquisition element and memory element for generation of an application program for implementation by the processing element, said means for selectively physically reconnecting the processing element to the data acquisition element and memory element when the external application development device is disconnected from the external programming connector.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 illustrates one exemplary implementation of a method of building an original application program for a computing device having a data acquisition device;

FIG. 2 illustrates one exemplary implementation of a DAQ-containing computing device and an external application development device;

FIG. 3 illustrates another exemplary implementation of a method of developing an application program for a DAQ system; and

FIG. 4 illustrates one exemplary implementation of a computing device for association with a DAQ device and/or as an external application development device.

### DETAILED DESCRIPTION

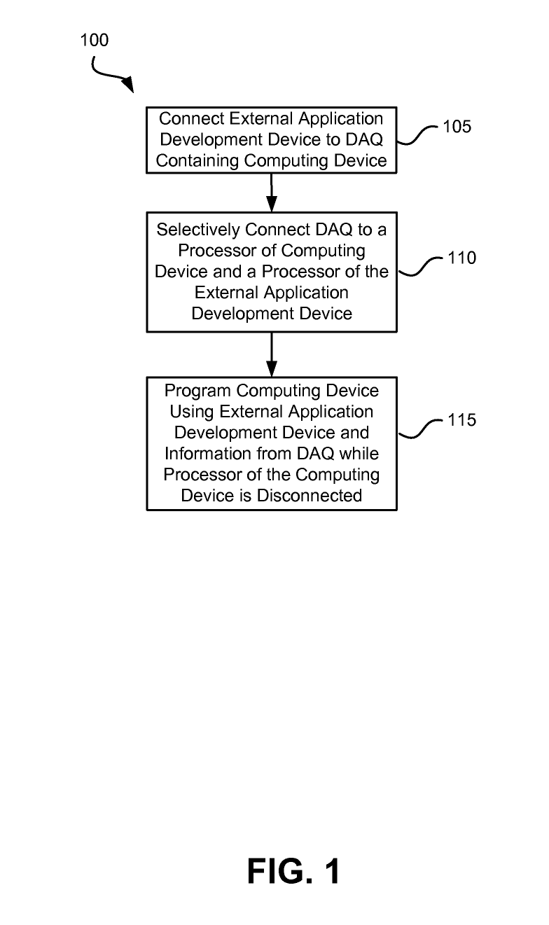

FIG. 1 illustrates one exemplary implementation of a method 100 of building an original application program for a computing device having a data acquisition device (commonly known as a DAQ device). Exemplary DAQ devices are discussed further below. At step 105, an external application development device is connected to the DAQ containing computing device. An external application development device is any device that includes a processing element configured with hardware and/or software (e.g., machine executable instructions) for authoring, monitoring, completing the development, and/or debugging of an application program for implementation on a different computing device having a DAQ associated therewith. Example devices that may be configured as an external application development device include, but are not limited to, a computer workstation, a terminal computer, a server computer, a laptop computer, a handheld computing device (e.g., tablet computer, a personal digital assistant “PDA”, a mobile telephone, a BLACKBERRY mobile device, an IPHONE portable computing device, other portable computing/telecommunication devices, etc.), a web appliance, a network router, a network switch, a network bridge, any machine capable of executing a sequence of instructions that specify an action to be taken by that machine, and any combinations thereof. Ways of connecting the external application development device to the DAQ containing computing device include, but are not limited to, a direct wired connection (e.g., a serial connection, such as USB; a FIREWIRE connection), a wired network connection (e.g., a local area network, a wide area network, a virtual network), a connection including the Internet, a direct wireless connection (e.g., BLUETOOTH, infrared), a wireless network connection (e.g., an 802.11 protocol network, a telecommunication carrier network), and any combinations thereof.

At step 110, the DAQ of the computing device is selectively connected to one or more processing elements of the computing device and one or more processing elements of the external application development device. In one example, the DAQ is connected to one or more of the processing elements of the DAQ containing computing device and not connected to the processing elements of the external application development device such that information from the DAQ is deliverable to the one or more processing elements of the DAQ containing computing device. In another example, the DAQ is connected to one or more of the processing elements of the external application development device and not connected to the one or more processing elements of the DAQ containing computing device such that information from the DAQ is deliverable to the one or more processing elements of the external application development device.

At step 115, the DAQ-containing computing device is programmed utilizing the one or more processors of the external application development device and information from the DAQ while the one or more processors of the DAQ-containing computing device is disconnected from the DAQ. The programming includes development of an application program (including appropriate machine executable instructions) that is configured to operate on the DAQ-containing computing device after the external application development device is disconnected from the DAQ-containing computing device. Development of the application program can include coding the instructions for executing the application program, monitoring the performance of the application program being developed, debugging the application program, compiling the instructions of the application program, and any combinations thereof.

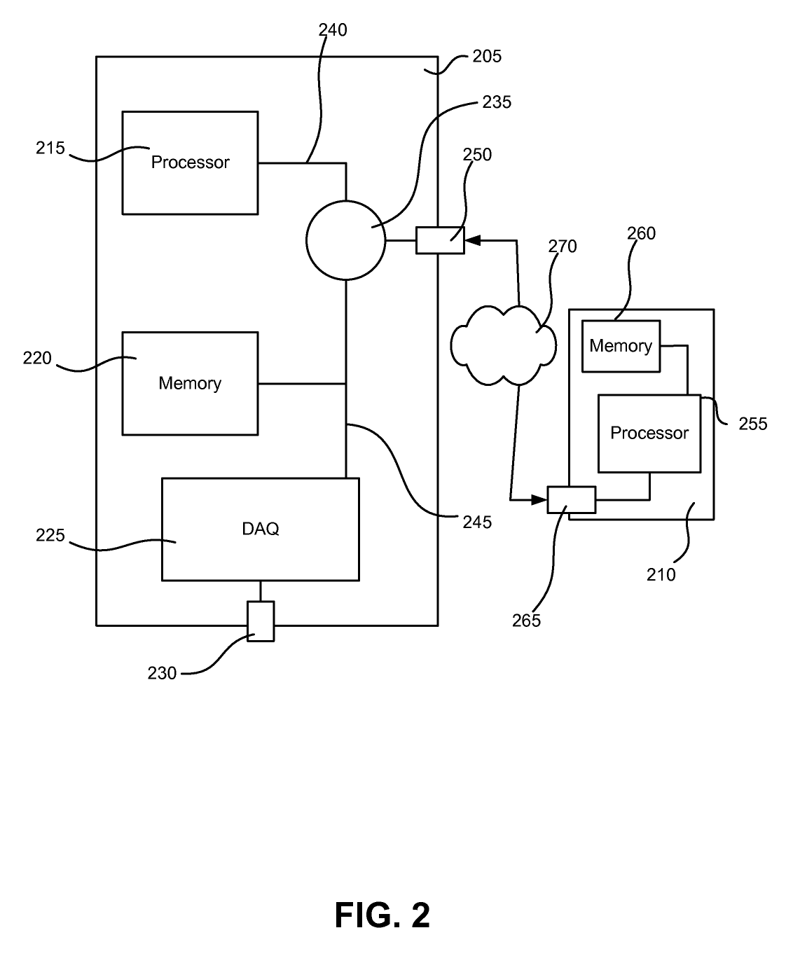

FIG. 2 illustrates one exemplary implementation of a DAQ-containing computing device 205 and an external application development device 210. Computing device 205 includes one or more processing elements 215, a memory element 220, a DAQ device 225, and a DAQ external connector 230. One or more processing elements 215 may include any type of processing elements. Example processing elements include, but are not limited to, a microprocessor, a microcontroller, a field programmable gate array (FPGA), system-on-module (SOM), and any combinations thereof. Example microprocessors include, but are not limited to, Pentium, Celeron, ATOM, ARM, and any combinations thereof. Example memory elements include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. Memory element 220 may be positioned inside a housing of computing device 205, outside a housing of computing device 210, or any combination thereof. In one example, memory element 220 includes a removable memory element. DAQ 225 may include any one or more of the typical components of a data acquisition device. Example data acquisition devices include various components including, but not limited to, one or more sensors for converting physical parameters to electrical signals, signal conditioning circuitry, analog-to-digital conversion circuitry to convert analog parameter signals to a digital format, counter/timer circuitry for counting digital events or producing digital output pulses, and any combinations thereof. DAQ external connector 230 is configured to connect external devices that are to have one or more physical parameters delivered to DAQ 225. In one example, one or more sensors connected to an external device being monitored for physical parameters is connected to DAQ external connector 230. Example connectors for DAQ external connector 230 include, but are not limited to, a serial connector (e.g., a DB-25 connector), screw terminals, spring terminals, and any combinations thereof. DAQ 225 and DAQ external connector 230 may be positioned inside the housing of computing device 205, outside the housing of computing device 205, or any combination thereof. In one example, DAQ 225 includes a card unit that is connected to the circuitry of computing device 205. In another example, DAQ 225 includes a removable card unit that can be removably connected with the circuitry of computing device 205.

DAQ-containing computing device 205 also includes a programming selector circuitry 235. One or more processing elements 215 is connected to programming selector circuitry 235 via circuit bus 240. DAQ 225 and memory 220 are connected to programming selector circuitry 235 via circuit bus 245. An external programming connector 250 is also connected to programming selector circuitry 235. Programming selector circuitry 235 is configured to selectively switch the connection of external programming connector 250 between one or more processing elements 215 and DAQ 225. Circuit bus 240 and 245 may be any type of circuit bus known to be suitable for connecting circuit components of a computing device. Examples of circuit buses include, but are not limited to, a universal serial bus (USB)-type connection, FireWire, Ethernet, PCI, PCI Express, PXI, PXI Express, and any combinations thereof. In one example, circuit bus 240 and circuit bus 245 are USB connections. External programming connector 250 can be any connector capable of connecting computing device 205 to external application development device 210. Example connectors for external programming connector 250 include, but are not limited to, a USB connector, a serial connector, an Ethernet connector, a FireWire connector, a proprietary connector, a wireless connector, and any combinations thereof. In one example, external programming connector 250 is a USB connector. External programming connector 250 may be positioned inside the housing of computing device 205 (e.g., in the case of a wireless connector with an antenna inside the housing), outside the housing of computing device 205, or any combination thereof. Computing device 205 may also include circuitry between external programming connector 50 and programming selector circuitry 235 suitable for converting data signals from a format compatible to a type of connector used for external programming connector 250 to and/or from a format compatible to circuit bus 240 and/or circuit bus 245. For example, where external programming connector 250 includes a wireless connector (e.g., an 802.11 circuit and associated antenna) and circuit buses 240 and 245 are USB, computing device 205 may include circuitry for converting data to and/or from a format compatible with the wireless protocol used by the wireless connector and a USB protocol used by the internal circuit buses. Such conversion circuitry may be located at any one or more various locations of computing device 205 including, but not limited to, as part of external programming connector 250, as part of programming selector circuitry 235, between external programming connector 250 and programming selector circuitry 235, and any combinations thereof.

Example circuits for inclusion in programming selector circuitry 235 include, but are not limited to, a USB multi-switch device capable of switching between masters, a FireWire multi-switch device capable of switching between masters, an Ethernet multi-switch device capable of switching between masters, and any combinations thereof. One example of a USB multi-switch device is a model USB2524 available from SMSC located in Hauppauge, N.Y.

External application development device 210 includes one or more processing elements 255, a memory element 260, and an external connector 265.

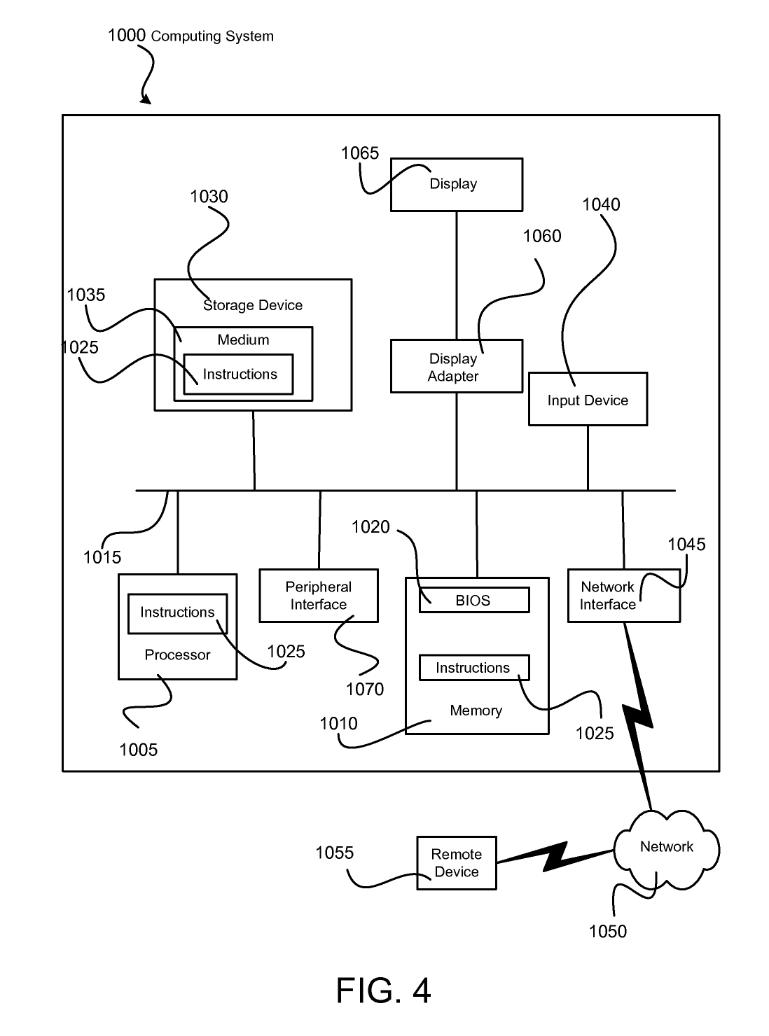

FIG. 2 shows a connection 270 between external programming connector 250 and external connector 265. External connection 270 may any type of connection for connecting external programming connector 250 and external connector 265 (e.g., such that it allows one or more processing elements 255 to connect with DAQ 225). Example connections include, but are not limited to, a direct wired connection, a wired network connection, a wireless network connection, a wireless direct connection, and any combinations thereof. Exemplary networks are discussed below with respect to FIG. 4.

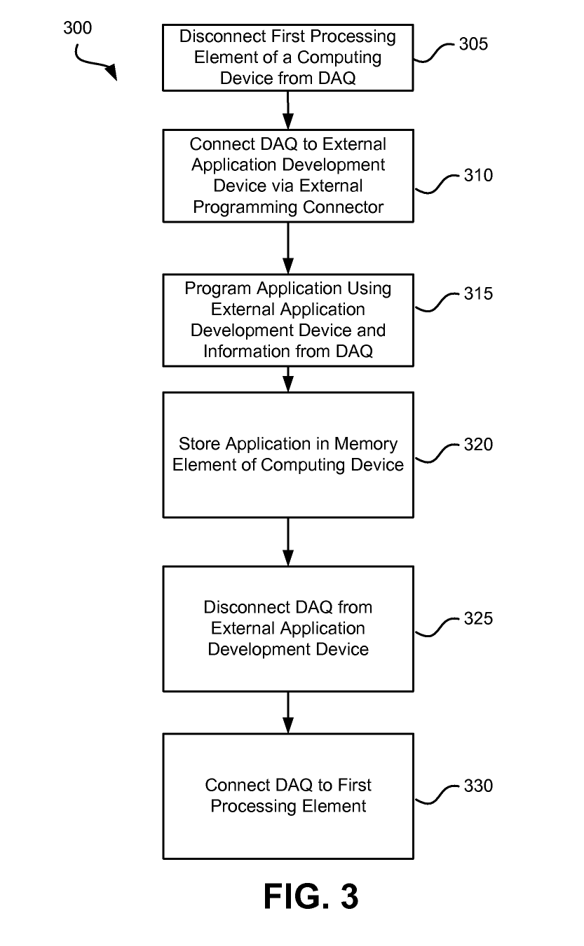

FIG. 3 illustrates another example of a method 300 of building an original application program for a computing device having a DAQ. One exemplary implementation of method 300 will now be discussed with respect to the exemplary DAQ-containing computing device 205 and external application development device 210 of FIG. 2.

At step 305, one or more processing elements 215 is disconnected from DAQ 225 using programming selector circuitry 235. In one example, this disconnection is automatic upon connection of external application development device 210 to external programming connector 250.

At step 310, DAQ 225 is connected to one or more processing elements 255 by programming selector circuitry 235. In one example, a connection between DAQ 225 and external programming connector 250 is automatic upon connection of external application development device 210 to external programming connector 250. In one alternative example, step 310 may occur prior to step 305. In another alternative example, steps 310 and 305 may occur substantially simultaneously.

At step 315, an application program is developed using one or more processors 255 and information received by one or more processors 255 from DAQ device 225. As discussed above, the development of the application program can include coding the instructions for executing the application program, monitoring the performance of the application program being developed, debugging the application program, compiling the instructions of the application program, and any combinations thereof. The information received from DAQ 225 may include any information regarding the configuration, operation, performance of DAQ 225, one or more sensors connected thereto (e.g., via external connector 230), real world signals being acquired by DAQ 225, and any combinations thereof. In one example, the application program is developed using information from DAQ device 225 and application program components and/or application development tools stored on external application development device 210 (e.g., in memory element 260). In another example, the application program is developed using one or more processors 255, information from DAQ device 225, and application program components and/or application development tools stored in memory element 220. In one such example, application components may be stored in memory element 220 prior to connection of external application development device 210. In yet another example, the application program is developed using one or more processors 255, information from DAQ device 225, and application program components and/or application development tools stored in memory element 220 and memory element 260. Many application development tools are available for developing driver and/or analysis application programs for a DAQ-device containing system. Some such systems utilize pre-built application components in developing such an application program. Example development tools include, but are not limited to, LabVIEW, ANSI C, C++, Visual Basic, Visual Basic. NET, C#.NET, Java Assembler, and any combinations thereof.

Development of the application program may require multiple debugging and/or compiling cycles prior to the completion of the application program. Development may also include having the DAQ-containing computing device connected to the real-world conditions that the program is being developed for use with. For example, the application program can be developed while monitoring (using the one or more processing elements of the external application development device) the acquisition of real-world parameters by the DAQ device. An exemplary implementation as described herein may include the exemplary aspect of allowing for flexibility of changing the capabilities of a DAQ system rapidly by developing an application program and/or monitoring the real-world implementation of an interim or completed version of an application program using an external application development device (e.g., while the DAQ system is still operating). In another exemplary aspect, selectively displacing the one or more processing elements of a DAQ system with the processing elements of an external application development device may provide any one or more of the benefits of larger screen, keyboard, and mouse.

At step 320, the application program is stored in memory element 220. At step 325, DAQ 225 is disconnected from one or more processors 255 using programming selector circuitry 235. In one example, a disconnection of DAQ 225 from external program connector 250 is automatic upon disconnection of external application development device 210 from external programming connector 250.

At step 330, DAQ 225 is reconnected to one or more processing elements 215 using programming selector circuitry 235. In one example, a connection between one or more processors 215 and DAQ 225 is automatic upon disconnection of external application development device 210 from external programming connector 250.

As shown in FIG. 2, selective connection and disconnection of one or more processing elements 215 to external connector 250 using programming selector circuitry 235 will also selectively disconnect and connect memory element 220 to external connector 250 along with DAQ 225. It is contemplated that one or more memory elements associated with a DAQ device-containing system may be left connected to the one or more processing elements of the system when an external application development device is connected. In one example, the one or more memory elements of the DAQ device-containing system are physically connected to a programming selector circuitry by one physical connection and also connected to the one or more processor elements of the DAQ device-containing system such that when the programming selector circuitry disconnects a DAQ from an external connector, the one or more memory elements remains connected to the one or more processor elements of the DAQ device-containing system. In another example, the one or more memory elements of the DAQ device-containing system are physically connected to one or more processing elements of the DAQ device-containing system and are not wired in a manner to be disconnected via a programming selector circuitry (e.g., at least one of the one or more memory elements is connected to the external connector of the system such that it remains connected with the selective connection/disconnection of the DAQ from the connection to the one or more processing elements of the DAQ device-containing system).

It is to be noted that appropriate application development coding can readily be prepared by skilled programmers based on the teachings of the present disclosure, as will be apparent to those of ordinary skill in the DAQ application program art. Such application program may include a computer program product that employs a machine-readable medium. A machine-readable medium may be any medium that is capable of storing and/or encoding a sequence of instructions for execution by a machine (e.g., a computing device) and that causes the machine to perform any one of the methodologies and/or embodiments described herein. One or more memory elements of a DAQ system as described herein (e.g., memory 220, 260) may include one or more machine-readable media. Examples of a machine-readable medium include, but are not limited to, a magnetic disk (e.g., a conventional floppy disk, a hard drive disk), an optical disk (e.g., a compact disk “CD”, such as a readable, writeable, and/or re-writable CD; a digital video disk “DVD”, such as a readable, writeable, and/or rewritable DVD), a magneto-optical disk, a read-only memory “ROM” device, a random access memory “RAM” device, a magnetic card, an optical card, a solid-state memory device (e.g., a flash memory), an EPROM, an EEPROM, and any combinations thereof. A machine-readable medium, as used herein, is intended to include a single medium as well as the possibility of including a collection of physically separate media, such as, for example, a collection of compact disks or one or more hard disk drives in combination with a computer memory.

Examples of a computing device (e.g., device 205, 210) include, but are not limited to, a computer workstation, a terminal computer, a server computer, a handheld device (e.g., tablet computer, a personal digital assistant “PDA”, a mobile telephone, a BLACKBERRY mobile device, etc.), a web appliance, a network router, a network switch, a network bridge, programmable logic controller (“PLC”), any machine capable of executing a sequence of instructions that specify an action to be taken by that machine, and any combinations thereof.

FIG. 4 shows a diagrammatic representation of one implementation of a machine/computing device in the exemplary form of a computer system 1000 within which a set of instructions for causing the device to perform any one or more of the aspects and/or methodologies of the present disclosure may be executed. Computer system 1000 includes a processor 1005 and a memory 1010 that communicate with each other, and with other components, via a bus 1015. Bus 1015 may include any of several types of bus structures including, but not limited to, a memory bus, a memory controller, a peripheral bus, a local bus, and any combinations thereof, using any of a variety of bus architectures. Such a bus may be in addition to connections between one or more processing elements of a DAQ device-containing system and an associated DAQ device (e.g., connections 240 and 245 of FIG. 2).

Memory 1010 may include various components (e.g., machine readable media) including, but not limited to, a random access memory component (e.g, a static RAM “SRAM”, a dynamic RAM “DRAM”, etc.), a read only component, and any combinations thereof. In one example, a basic input/output system 1020 (BIOS), including basic routines that help to transfer information between elements within computer system 1000, such as during start-up, may be stored in memory 1010. In one example, a system with an associated DAQ device (e.g., device 205) may utilize a BIOS and/or an application program developed by an external application development device (e.g., device 210) and stored in a memory (e.g., memory 220) in handling basic routines for startup and/or operation of elements of the system. Memory 1010 may also include (e.g., stored on one or more machine-readable media) instructions (e.g., software) 1025 embodying any one or more of the aspects and/or methodologies of the present disclosure. In another example, memory 1010 may further include any number of program modules including, but not limited to, an operating system, one or more application programs, other program modules, program data, and any combinations thereof.

Computer system 1000 may also include a storage device 1030. Examples of a storage device (e.g, storage device 1030) include, but are not limited to, a hard disk drive for reading from and/or writing to a hard disk, a magnetic disk drive for reading from and/or writing to a removable magnetic disk, an optical disk drive for reading from and/or writing to an optical media (e.g., a CD, a DVD, etc.), a solid-state memory device, and any combinations thereof. Storage device 1030 may be connected to bus 1015 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1030 may be removably interfaced with computer system 1000 (e.g., via an external port connector (not shown)). Particularly, storage device 1030 and an associated machine-readable medium 1035 may provide nonvolatile and/or volatile storage of machine-readable instructions, data structures, program modules, and/or other data for computer system 1000. In one example, software 1025 may reside, completely or partially, within machine-readable medium 1035. In another example, software 1025 may reside, completely or partially, within processor 1005.

Computer system 1000 may also include an input device 1040. In one example, a user of computer system 1000 may enter commands and/or other information into computer system 1000 via input device 1040. Examples of an input device 1040 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. Input device 1040 may be interfaced to bus 1015 via any of a variety of interfaces (not shown) including, but not limited to, a serial interface, a parallel interface, a game port, a USB interface, a FIREWIRE interface, a direct interface to bus 1015, and any combinations thereof.

A user may also input commands and/or other information to computer system 1000 via storage device 1030 (e.g., a removable disk drive, a flash drive, etc.) and/or a network interface device 1045. A network interface device, such as network interface device 1045 may be utilized for connecting computer system 1000 to one or more of a variety of networks, such as network 1050, and one or more remote devices 1055 connected thereto. Examples of a network interface device include, but are not limited to, a network interface card, a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a direct connection between two computing devices, and any combinations thereof. A network, such as network 1050, may employ a wired and/or a wireless mode of communication. In general, any network topology may be used. Information (e.g., data, software 1025, etc.) may be communicated to and/or from computer system 1000 via network interface device 1045.

Computer system 1000 may further include a video display adapter 1060 for communicating a displayable image to a display device, such as display device 1065. Examples of a display device include, but are not limited to, a liquid crystal display (LCD), a cathode ray tube (CRT), a plasma display, and any combinations thereof. In addition to a display device, a computer system 1000 may include one or more other peripheral output devices including, but not limited to, an audio speaker, a printer, and any combinations thereof. Such peripheral output devices may be connected to bus 1015 via a peripheral interface 1070. Examples of a peripheral interface include, but are not limited to, a serial port, a USB connection, a FIREWIRE connection, a parallel connection, and any combinations thereof. In one example, a display device and/or other peripheral device may be utilized to output to a user information related to data and/or analysis of real-world conditions acquired by the DAQ system.

A digitizer (not shown) and an accompanying pen/stylus, if needed, may be included in order to digitally capture freehand input. A pen digitizer may be separately configured or coextensive with a display area of display device 1065. Accordingly, a digitizer may be integrated with display device 1065, or may exist as a separate device overlaying or otherwise appended to display device 1065.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of building an original application program for operating with a data acquisition device of a computing device having an external programming connector and a first processing element, the method comprising:
disconnecting the first processing element from the data acquisition device and connecting the data acquisition device via the external programming connector to an external application development device;
programming an application program for implementation on the computing device using a second processing element of the external application development device and information from the data acquisition device;
storing the application program in a memory element of the computing device; and
disconnecting the data acquisition device from the external application development device and connecting the data acquisition device to the first processing element.

2. A method of building an original application program for operating a computing device having a data acquisition device and processor, the method comprising:
connecting a first computing device having a first processing element to a second computing device via an external programming connector of the second computing device, the second computing device having a second processing element and a data acquisition device;
automatically connecting the external programming element to the data acquisition device and disconnecting the second processing element from the data acquisition device;
generating an application program for implementation on the second computing device using the first processing element and information from the connection to the data acquisition device;
storing the application program in a memory element of the second computing device;
disconnecting the first computing device from the external programming connector; and
automatically connecting the data acquisition device to the second processing element and disconnecting the data acquisition device from the external programming connector.

3. A method according to claim 2, further comprising running the application program on the second computing device using the second processing element and the data acquisition device.

4. A method according to claim 2, further comprising automatically disconnecting the memory element from the second processor and connecting the memory element to the external programming connector when the first computing device is connected to the second computing device.

5. A method according to claim 4, further comprising disconnecting the memory element from the external programming connector and connecting the memory element to the second processor after said generating step.

6. A method according to claim 2, further comprising disconnecting the memory element from the external programming connector and connecting the memory element to the second processor after said generating step.

7. A method according to claim 2, wherein said generating the application program comprises using the first computing device to simulate the utilization of the second computing device and the data acquisition device using the application program and the first processing element.

8. A method according to claim 2, wherein said generating the application program comprises monitoring the performance of the application program being generated.

9. A method according to claim 2, wherein said generating the application program comprises completion of the application program from component application elements.

10. A method according to claim 8, wherein the component application elements are located prior to said connecting of the first computing device in the memory element.

11. A method according to claim 8, wherein the component application elements are located prior to said connecting of the first computing device in the first computing device.

12. A method according to claim 2, wherein said generating the application program comprises multiple debugging and compiling cycles prior to completion of the application program.

13. A method according to claim 2, wherein said automatically connecting the external programming element to the data acquisition device and disconnecting the second processing element from the data acquisition device includes use of an auto-switching USB connector.

14. A method according to claim 2, wherein the second processor and data acquisition device are connected using a USB connection.

15. A method according to claim 2, wherein the external programming connector includes a connector selected from the group consisting of a USB connector, a serial connector, a wireless connector, a FireWire connector, a proprietary connector, an Ethernet connector, and any combinations thereof.

16. A method according to claim 2, wherein the memory element includes a removable memory element.

17. A method according to claim 14, wherein the memory element includes a memory element selected from the group consisting of a thumb drive, a flash memory card, a hard drive, an optical disk, a magnetic disk, a solid-state-disk drive, and any combinations thereof.

18. A method according to claim 2, wherein the memory element includes a memory element selected from the group consisting of a flash memory device, a hard drive, an optical memory element, a magnetic disk element, a circuit-based memory element, a solid-state-disk drive, and any combinations thereof.

19. A data acquisition system comprising:
a processing element;
a data acquisition element connected via a wired connection to the processing element;
a memory element connected via a wired connection to the processing element;
an external programming connector;
means for selectively physically disconnecting the data acquisition element and memory element from the processing element and connecting the data acquisition element and memory element to the external programming connector when the external programming connector is connected to an external application development device such that a processor of the external application development device can access the data acquisition element and memory element for generation of an application program for implementation by the processing element, said means for selectively physically reconnecting the processing element to the data acquisition element and memory element when the external application development device is disconnected from the external programming connector.

20. A data acquisition system according to claim 18, wherein the means for selectively physically disconnecting includes a USB switch.

21. A data acquisition system according to claim 18, wherein the wired connection includes a USB connection.

22. A data acquisition system according to claim 18, wherein the memory element includes components of the application program prior to the connection of the external application development device.
